(19) United States
(12) Patent Application Publication
(10) Pub. No.: US 2023/0202809 A1
(43) Pub. Date: Jun. 29, 2023

(54) CRANE

(71) Applicant: Xuzhou Construction Machinery Group Co., Ltd., Xuzhou (CN)

(72) Inventors: Weidong Chen, Xuzhou (CN); Li Sun, Xuzhou (CN); Jinjun Meng, Xuzhou (CN); Xixiang Jiang, Xuzhou (CN); Lei Han, Xuzhou (CN); Shiquan Song, Xuzhou (CN); Yulong Zhou, Xuzhou (CN)

(21) Appl. No.: 17/910,674

(22) PCT Filed: Nov. 19, 2020
(86) PCT No.: PCT/CN2020/129938

§ 371 Date: Sep. 9, 2022

(30) Foreign Application Priority Data
Mar. 13, 2020 (CN) 202010173433.2

(51) Int. Cl. B66C 23/76; B66C 23/36; B66C 13/16

(52) U.S. Cl. CPC B66C 23/76; B66C 23/36; B66C 13/16; B66C 2700/0342

(57) ABSTRACT

The present disclosure discloses a crane, including: a chassis; a rotatable platform, rotatably arranged on the chassis; a main arm, including a first end hinged with a first end of the rotatable platform, and a second end for lifting a weight; a mast, configured to luff the main arm, wherein a first end of the mask is hinged with the first end of the rotatable platform, and a second end of the mast is connected to the second end of the main arm and a second end of the rotatable platform; and a first independent counterweight system, including a first independent counterweight, and a connecting structure connected between the first independent counterweight and the rotatable platform, wherein the connecting structure is configured to enable the first independent counterweight to be in a partial working state, and in the partial working state, the first independent counterweight is supported on the ground and the weight of the first independent counterweight is supported jointly by the ground and the rotatable platform.

### CROSS-REFERENCE TO RELATED APPLICATIONS

This application claims priority to Chinese Application No. 202010173433.2, filed on Mar. 13, 2020, entitled “CRANE”, the contents of which are incorporated herein by reference in its entirety.

### FIELD OF THE DISCLOSURE

The present disclosure relates to engineering machinery, and in particular, to a crane.

### BACKGROUND OF THE DISCLOSURE

Cranes, also known as hoists, are multi-action engineering machinery for vertically lifting and horizontally carrying weights in a certain range. The crane uses a hook to vertically lift the weight through the raising and lowering of a main arm (also known as a crane jib), and moves the weight in a horizontal direction through the slewing motion of the rotatable platform or the walking of the whole machine. In order to prevent the crane from overturning under the gravity action of the main arm and the weight when the weight is lifted, or prevent the crane from overturning under the gravity action of the main arm when the main arm gradually ascends from the ground, a counterweight is arranged on the rotatable platform of the crane to overcome an overturning moment generated by the gravity of the weight and the main arm during lifting, or overcome an overturning moment generated by the gravity of the main arm when the main arm ascends. However, due to the limited supporting capability of the rotatable platform of the crane and the slewing supporting structure for supporting the rotatable platform, in order to improve the lifting capacity of the crane, too many counterweights are arranged on the rotatable platform, which will cause too large workload of the rotatable platform or the slewing supporting structure, even cause damage to structural components.

### SUMMARY OF THE DISCLOSURE

The present disclosure discloses a crane, including:

a chassis;

a rotatable platform, rotatably arranged on the chassis and including a first end and a second end which are opposite to each other;

a main arm, including a first end hinged with the first end of the rotatable platform, and a second end for lifting a weight;

a mast, configured to luff the main arm, wherein a first end of the mast is hinged with the first end of the rotatable platform, and a second end of the mast is connected to the second end of the main arm and the second end of the rotatable platform; and

a first independent counterweight system, including a first independent counterweight, and a connecting structure connected between the first independent counterweight and the second end of the rotatable platform, wherein the connecting structure is configured to enable the first independent counterweight to be in a partial working state, and in the partial working state, the first independent counterweight is supported on the ground and the weight of the first independent counterweight is supported jointly by the ground and the rotatable platform.

In some embodiments, the connecting structure includes a first lifting device; and the first lifting device is configured to raise or lower the first independent counterweight, so that the first independent counterweight is supported on the ground or separated from the ground.

In some embodiments, the crane further includes a counterweight fixedly arranged on the rotatable platform; and the first independent counterweight is detachably connected to the rotatable platform.

In some embodiments, the first independent counterweight is detachably connected to the rotatable platform. The crane further includes:

a counterweight, fixedly arranged on the rotatable platform;

a force sensor, arranged between the second end of the mast and the second end of the main arm and configured to detect a pulling force of the main arm on the mast; and

a control system, signally connected to the force sensor and the first lifting device and configured to: control the first lifting device to raise or lower the first independent counterweight according to the detection result of the force sensor.

In some embodiments, the first independent counterweight system includes a first connecting frame for connecting the rotatable platform and the connecting structure; and the first connecting frame extends away from the first end of the rotatable platform.

In some embodiments, the first connecting frame includes a first telescoping mechanism arranged between the connecting structure and the rotatable platform; and the first telescoping mechanism is configured to drive the first independent counterweight to be close to or away from the first end of the rotatable platform.

In some embodiments, the crane further includes:

a super-lifting arm frame, of which a first end is hinged with the first end of the rotatable platform and a second end is connected to the main arm and the second end of the mast; and

a second independent counterweight system, including a second independent counterweight, a second lifting device connected between the second independent counterweight and the second end of the super-lifting arm frame, and a second connecting frame connected between the second end of the rotatable platform and the second lifting device, wherein the second lifting device is configured to lift the second independent counterweight, so that the second independent counterweight is supported on the ground or separated from the ground.

In some embodiments, the second connecting frame includes a second telescoping mechanism; and the second telescoping mechanism is configured to drive the second independent counterweight to be close to or away from the first end of the rotatable platform.

In some embodiments, the crane includes a counterweight fixedly arranged at the second end of the rotatable platform; and the second independent counterweight is detachably connected to the rotatable platform.

Based on the crane provided by the present disclosure, the first independent counterweight system is provided, the first independent counterweight and the connecting structure for connecting the first independent counterweight onto the rotatable platform are provided, and the first independent counterweight has a partial working state, so that the first independent counterweight may be arranged on the ground. The first independent counterweight can exert the effect of stabilizing the crane to prevent the crane from overturning, the load of the rotatable platform and the slewing supporting structure for supporting the rotatable platform can be reduced, the working environment of the rotatable platform and the slewing supporting structure is improved, damage to the rotatable platform or the slewing supporting structure is reduced, and the service life of the rotatable platform and the slewing supporting structure is prolonged. The first independent counterweight can exert the effect of stabilizing the crane under the super-lifting working condition of the crane with a super-lifting device and the standard working condition of the crane without the super-lifting device.

Other features and advantages of the present disclosure will become apparent by the detailed description for exemplary embodiments of the present disclosure with reference to the following accompany drawings.

### BRIEF DESCRIPTION OF THE ACCOMPANYING DRAWINGS

The accompanying drawings described herein are used to provide further understanding of the present disclosure and constitute a part of the present application. The schematic embodiments of the present disclosure and the description thereof are used to explain the present disclosure, but do not constitute an inappropriate limitation to the present disclosure. In the accompanying drawings:

FIG. 1 is a structural schematic diagram of a crane according to an embodiment of the present disclosure.

FIG. 2 is a structural schematic diagram of a crane according to another embodiment of the present disclosure.

FIG. 3 is a structural schematic diagram of a crane according to another embodiment of the present disclosure.

### DETAILED DESCRIPTION OF THE PREFERRED EMBODIMENTS

The technical solutions in the embodiments of the present disclosure are described clearly and completely with reference to the accompanying drawings in the embodiments of the present disclosure. Apparently, the described embodiments are merely a part rather than all of the embodiments of the present disclosure. The following description of the at least one exemplary embodiment is actually merely illustrative and never constitutes any limitation to the present disclosure and application or use thereof. All other embodiments made on the basis of the embodiments of the present disclosure by a person of ordinary skill in the art without paying any creative effort shall be included in the protection scope of the present disclosure.

Unless otherwise specified, relative arrangement, numerical expressions and values of parts and steps described in the embodiments do not limit the scope of the present disclosure. Meanwhile, it should be understood that for the convenience of description, the dimensions of each part shown in the accompanying drawings are not drawn according to the actual proportional relationship. Technologies, methods and devices known to those of ordinary skill in the related field may not be discussed in detail, but, where appropriate, the technologies, methods and devices should be regarded as a part of the authorized specification. In all the examples shown and discussed herein, any specific value should be interpreted as merely exemplary rather than a limitation. Therefore, other examples of the exemplary embodiments may have different values. It should be noted that similar reference numerals and letters represent similar items in the accompanying drawings below. Therefore, once a certain item is defined in one drawing, it is unnecessary to further discuss the item in the subsequent drawings.

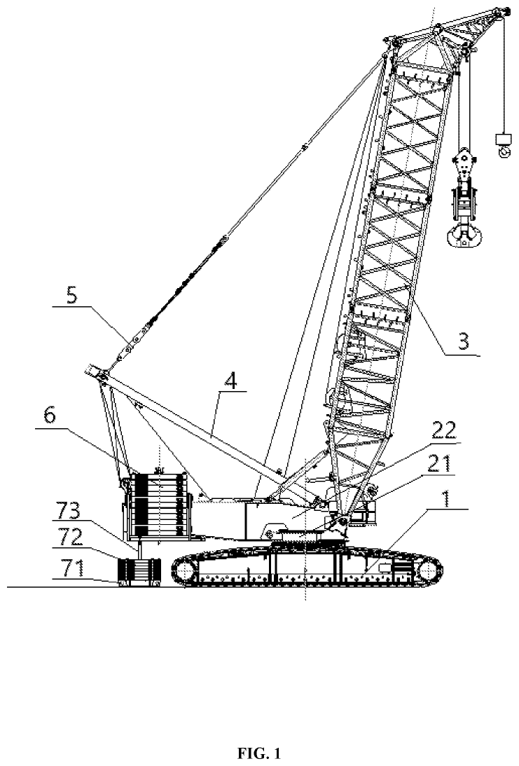

As shown in FIG. 1 to FIG. 3, the crane provided by the embodiment includes a chassis 1, a rotatable platform 22, a main arm 3, a mast 4 and a first independent counterweight system.

The rotatable platform 22 is rotatably arranged on the chassis 1 and includes a first end and a second end which are opposite to each other; and the rotatable platform 22 is supported on the chassis 1 through a slewing supporting structure 21. In some embodiments, the slewing supporting structure 21 includes a mechanism such as a slewing motor or a electric motor, for driving the rotatable platform 22 to rotate relative to the chassis 1. In some embodiments, the chassis 1 is a mobile chassis, such as a caterpillar chassis or a wheel type chassis. At this time, the crane is a mobile crane. In some embodiments, the chassis 1 is a static chassis. At this time, the crane is a non-mobile crane.

The main arm 3 includes a first end hinged with the first end of the rotatable platform 22, and a second end for lifting a weight. The main arm 3 is hinged on the first end of the rotatable platform 22 through its first end so as to rotate relative to the rotatable platform 22 to perform amplitude variation. The second end of the main arm 3 is configured to support the weight lifted by the hook.

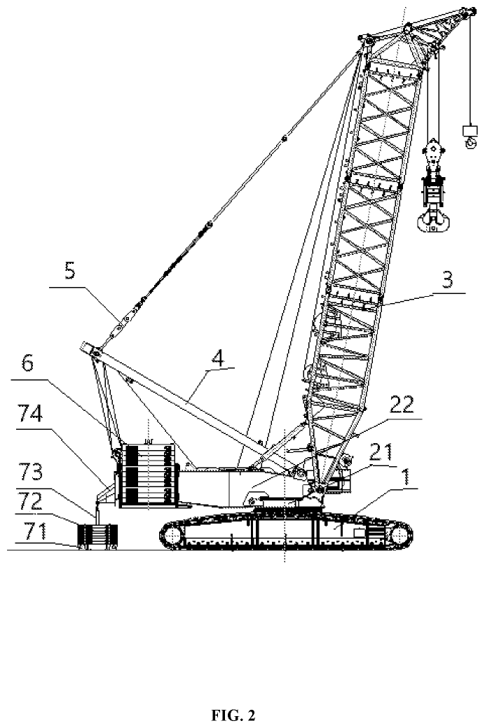

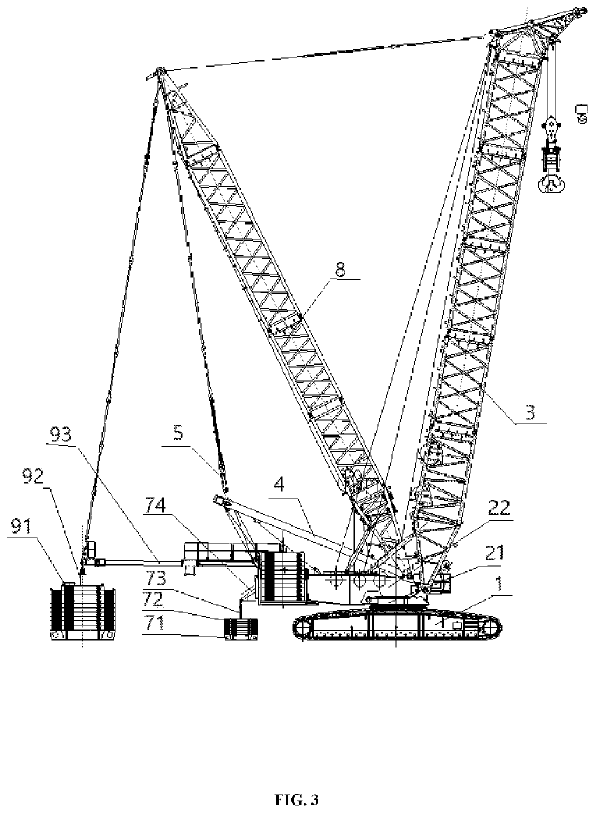

The first end of the mast 4 is hinged with the rotatable platform 22, and the second end is connected to the second end of the main arm 3 for luffing the main arm 3. In the embodiments of the crane without a super-lifting device, as shown in FIG. 1 and FIG. 2, the second end of the mast 4 is directly connected to the second end of the main arm 3 through a pull plate and/or a pull rope. In the embodiments of the crane with the super-lifting device, as shown in FIG. 3, the second end of the mast 4 is connected to a second end of a super-lifting arm frame 8 through a pull rope and/or a pull plate and then is connected to the second end of the main arm through the second end of the super-lifting arm frame 8, and the second end of the mast 4 is indirectly connected to the second end of the main arm 3.

The first independent counterweight system includes a first independent counterweight 72, and a connecting structure connected between the first independent counterweight 72 and the rotatable platform 22; the connecting structure is configured to enable the first independent counterweight 72 to be in a partial working state; in the partial working state of the first independent counterweight 72, the first independent counterweight 72 is supported on the ground, and the weight of the first independent counterweight 72 is supported jointly by the ground and the rotatable platform. In some embodiments, the first independent counterweight 72 includes a plurality of counterweight blocks and a counterweight tray 71 for bearing the plurality of counterweight blocks, as shown in the figures.

The connecting structure is connected between the first independent counterweight 72 and the rotatable platform 22. In some embodiments, the connecting structure is directly connected to the rotatable platform 22. In some embodiments, the connecting structure is indirectly connected to the rotatable platform 22 through other devices. When the first independent counterweight 72 is in the partial working state, the weight of the first independent counterweight 72 is supported jointly by the ground and the rotatable platform. At this time, the first independent counterweight 72 is hung on the rotatable platform through the connecting structure, and part of the weight the first independent counterweight 72 applies an action force to the rotatable platform through the connecting structure, so as to avoid the overturning of the crane when the crane lifts the weight and to stabilize the crane, and the remaining part of the weight of the first independent counterweight 72 is supported by the ground. As the weight of the weight lifted by the crane increases, before the first independent counterweight 72 is completely separated from the ground, the action force applied to the rotatable platform by the first independent counterweight 72 for preventing the crane from overturning may increase with the increase of the weight of the weight. When the first independent counterweight 72 is supported on the ground and the crane does not lift a weight or lifts a lighter weight, the weight of the first independent counterweight 72 may be all applied to the ground and will not apply pressure to the rotatable platform and the slewing supporting structure 21 for supporting the rotatable platform 22, thereby reducing the load of the slewing supporting structure 21.

According to the crane provided by the embodiment, the first independent counterweight system is provided, the connecting structure is provided for enabling the first independent counterweight 72 to be in a partial working state, and the first independent counterweight 72 may be arranged on the ground, so that in the assembling process of the main arm or when the crane does not lift a weight, an action force is not applied to the rotatable platform 22 and the slewing supporting structure 21. Or when a lighter weight is lifted, the first independent counterweight 72 has a partial working state, and only part of the weight of the first independent counterweight 72 forms load on the rotatable platform and the slewing supporting structure 21 and applies an action force. The first independent counterweight 72 can exert the effect of stabilizing the crane to prevent the crane from overturning, the load on the rotatable platform and the slewing supporting structure 21 for supporting the rotatable platform 22 can be reduced, the high-load working condition time of the rotatable platform 22 and the slewing supporting structure 21 can be reduced, damage to the rotatable platform and the slewing supporting structural component can be reduced, and the service life of the rotatable platform and the slewing supporting structure 21 can be prolonged. The first independent counterweight can stabilize the crane under the super-lifting working condition of the crane with a super-lifting device and the standard working condition of the crane without the super-lifting device.

In some embodiments, the connecting structure includes a first lifting device 73; and the first lifting device 73 is configured to raise or lower the first independent counterweight 72, so that the first independent counterweight 72 is supported on the ground, or the first independent counterweight 72 is separated from the ground, that is, the first independent counterweight 72 is lifted above the ground.

The first lifting device 73 can lift the first independent counterweight 72 into the air, or can also place the first independent counterweight 72 on the ground. When the first independent counterweight 72 is arranged on the ground and the crane does not lift a weight or lifts a lighter weight, the weight of the first independent counterweight 72 may be all applied to the ground and will not apply pressure to the rotatable platform and the slewing supporting structure 21 for supporting the rotatable platform 22, thereby reducing the load of the slewing supporting structure 21. When the crane lifts a heavier weight and it is necessary to apply stability action to the crane by the first independent counterweight 72, the first lifting device 73 can apply a lifting force to the first independent counterweight 72, so that an action force is transferred between the first independent counterweight 72 and the first lifting device 73, and the first independent counterweight 72 may all applied the weight to the rotatable platform 22 and the slewing supporting structure 21. When the first independent counterweight 72 applies a stabilizing effect to the crane, in some embodiments, the first independent counterweight 72 plays a full role (the first independent counterweight is separated from the ground), and in some embodiments the first independent counterweight 72 play a partial role (the first independent counterweight is not separated from the ground). When the first independent counterweight 72 is not separated from the ground, part of the weight of the first independent counterweight 72 acts on the ground, and the other part acts on the crane. When the first independent counterweight 72 applies a stabilizing effect, the weight acting on the crane of the first independent counterweight is transferred to the slewing supporting structure 21 through the rotatable platform 22 to form the load of the rotatable platform and the slewing supporting structure 21. When the first lifting device 73 lifts the first independent counterweight 72 above the ground, that is, the first independent counterweight 72 is hung in the air, the weight of the first independent counterweight 72 all acts on the crane, and the highest stabilizing effect can be applied. At this time, the crane can lift a heavier weight. When the rotatable platform 22 slews or the crane is a mobile crane, the crane can also carry the weight and the first independent counterweight 72 to walk. According to this embodiment, the first lifting device 73 is provided, and the first independent counterweight 72 can be arranged on the ground, so that in the assembling process of the main arm or when the crane does not lift a weight, an action force is not applied to the rotatable platform 22 and the slewing supporting structure 21, or when a lighter weight is lifted, the first independent counterweight 72 is not separated from the ground and only part of the weight form load on the rotatable platform and the slewing supporting structure 21 to apply the action force. Meanwhile, when it is necessary to slew the lifted weight, the first independent counterweight 72 can be lifted above the ground through the first lifting device 73, so that the rotatable platform 22 may perform slewing conveniently.

In some embodiments, the crane further includes a counterweight 6 arranged on the rotatable platform 22, and the first independent counterweight 72 is detachably connected to the rotatable platform 22. Detachable connection between the first independent counterweight 72 and the rotatable platform 22, in some embodiments is realized through detachable connection between the first independent counterweight 72 and the first lifting device 73, or in some embodiments through detachable connection between the connecting structure and the rotatable platform 22. In this embodiment, the crane can have various lifting abilities and adapt to various working environments. When the crane is applied to the working condition of lifting a lighter weight, or of a shorter main arm, the first independent counterweight 72 can be separated from the rotatable platform 22 and is disassembled, so that performing lifting, slewing, moving and other operations on the lighter weight can be conveniently with the counterweight 6. When the crane is applied to the working condition of lifting a heavier weight, or of a longer main arm, the first independent counterweight 72 can be connected to the rotatable platform 22, and the crane has higher lifting ability through the combined action of the first independent counterweight 72 and the counterweight 6.

In some embodiments, the first independent counterweight 72 is detachably connected to the rotatable platform; the crane further includes a counterweight 6 arranged on the rotatable platform 22; and a force sensor 5 for detecting a pulling force of the main arm 3 on the mast 4 is arranged between the second end of the mast 4 and the second end of the main arm 3. The crane further includes a control system which is signally connected to the force sensor 5 and the first lifting device 73; and the control system is configured to: control the first lifting device 73 to raise or lower the first independent counterweight 72 according to the detection result of the force sensor 5. When the crane lifts a weight, the larger the weight of the weight is, or when the crane lifts the arm, the longer the main arm is, the larger the pulling force between the second end of the mast 4 and the second end of the main arm 3 is, and the larger the moment which may cause the crane to overturn is, so that the larger the necessary stabilizing effect of the counterweight is. The force sensor 5 can determine the necessary stabilizing effect and the necessary magnitude of the stabilizing moment of the counterweight for ensuring that the crane does not overturn by measuring the magnitude of the pulling force. In this embodiment, in the process of lifting the weight and before the weight is completely lifted, the control system can determine whether it is necessary to exert the action of the first independent counterweight 72 except the counterweight according to the measurement result of the force sensor 5; and when it is determined that it is necessary to exert the action of the first independent counterweight 72, the first lifting device 73 can gradually lift the first independent counterweight 72 in a matched way with the gradual lifting of the weight, and the process that the first independent counterweight 72 is gradually separated from the ground is matched with the process that the weight is lifted, so that the stability of the crane in the process of lifting the weight is improved.

In some embodiments, as shown in FIG. 2 and FIG. 3, the first independent counterweight system includes a first connecting frame 74 for connecting the rotatable platform 22 and the first lifting device 73. The first connecting frame 74 extends away from the first end in a direction from the first end of the rotatable platform 22 to the second end. In some embodiments the first lifting device 73 is a device with a lifting function, such as a telescopic oil cylinder, a rope row, and the like. When the first independent counterweight 72 is connected to the first connecting frame 74 and the first independent counterweight 72 exerts the effect of stabilizing the crane, the first connecting frame 74 can increase the size of the force arm of the anti-overturning moment provided by the first independent counterweight 72, so that the weight of the first independent counterweight 72 can be reduced during structural design.

In some embodiments, the first connecting frame 74 includes a first telescoping structure arranged between the connecting structure and the rotatable platform 22, and the first telescoping mechanism is configured to drive the first independent counterweight 72 to be close to or away from the first end of the rotatable platform. In this embodiment, through the first telescoping mechanism, the length of the first connecting frame 74 extending away from the first end of the rotatable platform 22 can be adjusted, so that the size of the force arm can be adjusted when the first independent counterweight 72 exerts the effect of stabilizing the first independent counterweight 72.

In some embodiments, as shown in FIG. 3, the crane further includes: a super-lifting arm frame 8 and a second independent counterweight system.

The first end of the super-lifting arm frame 8 is hinged with the rotatable platform 22, and the second end is connected to the second end of the main arm 3; the first end of the mast 4 is hinged with the first end of the rotatable platform 22, and the second end is connected to the second end of the super-lifting arm frame 8; and the second independent counterweight system includes a second independent counterweight 91, a second lifting device 92 for connecting the second independent counterweight 91 and the second end of the super-lifting arm frame 8, and a second connecting frame 93 connected between the second end of the rotatable platform 22 and the second lifting device 92. The second lifting device 92 is configured to lift the second independent counterweight 91, so that the second independent counterweight 91 can be supported on the ground or separated from the ground. The second lifting device 92 is connected to the second end of the super-lifting arm frame 8 through a pull plate, a pull rope and/or other structures. Similar to the lifting action principle of the first lifting device 73 on the first independent counterweight 72, when the second lifting device 92 lifts the second independent counterweight to the air, the weight of the second independent counterweight 91 all acts on the crane, so that the stabilizing effect of the second independent counterweight 91 can be exerted maximally. In addition, a second connecting frame 93 may effectively increase the force arm when the second independent counterweight 91 exerts the effect of stabilizing the crane, thereby reducing the weight of the second independent counterweight 91; meanwhile, the second independent counterweight system is arranged below the super-lifting arm frame 8, and the stress state of the super-lifting arm frame 8 can be improved. In this embodiment, the second independent counterweight system is provided, so that the lifting ability of the crane can be effectively improved.

In some embodiments, the second connecting frame 93 includes a second telescoping mechanism, and the second telescoping mechanism is configured to drive the second independent counterweight 91 to be close to or away from the first end of the rotatable platform. The second telescoping mechanism is provided, so that the size of the force arm when the second independent counterweight 91 exerts the effect of stabilizing the crane can be adjusted. In some embodiments the second telescoping mechanism, like the first telescoping mechanism, includes a telescoping device such as a telescopic oil cylinder, a linear motor and the like.

In some embodiments, the crane further includes a counterweight 6 arranged on the rotatable platform 22; the first independent counterweight 72 and the second independent counterweight 91 are detachably connected to the rotatable platform 22; a force sensor 5 for detecting the pulling force of the main arm 3 on the mast 4 is arranged between the second end of the mast 4 and the second end of the super-lifting arm frame 8; the crane further includes a control system which is signally connected to the force sensor 5, the first lifting device 73 and the second lifting device; and the control system is configured to: control the first lifting device 73 to lift the first independent counterweight 72 and control the second lifting device to lift the second independent counterweight 91 according to the detection result of the force sensor 5. The first independent counterweight 72 and the second independent counterweight 91 are detachably connected to the rotatable platform 22, so that the crane may have various lifting abilities through the combination of disconnection or connection of the first independent counterweight 72, the second independent counterweight 91 and the rotatable platform 22, and the crane is suitable for more working conditions. Through the force sensor 5, the lifting of the first independent counterweight 72 and the second independent counterweight 91 can be more matched with the process that the crane lifts the weight.

In some embodiments, the first independent counterweight 72 is still arranged on the ground, the connecting structure may be designed as a non-telescopic structural part such as a chain and a connecting plate, and the first independent counterweight 72 cannot be actively separated from the ground. At this time, the first independent counterweight 72 may still has a partial working state, still can improve the stabilizing effect of the crane and reduce the load on the rotatable platform, and has a simpler structure. The first independent counterweight can exert the effect of stabilizing the crane under the super-lifting working condition of the crane with a super-lifting device and the standard working condition of the crane without the super-lifting device.

In some embodiments, the control system described above may be a general-purpose processor for performing the function described by the present disclosure, a programmable logic controller (PLC), a digital signal processor (DSP), an application specific integrated circuit (ASIC), a field-programmable gate array (FPGA) or other programmable logic devices, a discrete gate or a transistor logic device, a discrete hardware disassembly or any appropriate combination.

Finally, it should be noted that the above embodiments are merely intended to illustrate the technical solutions of the present disclosure and are not to limit them. Although the present disclosure has been illustrated in detail with reference to the preferred embodiments, those of ordinary skill in the art should understand that modification may be made on the specific embodiments of the present disclosure or equivalent replacement may be made on part of the technical features; and the modification and the equivalent replacement should be covered within the protection scope of the technical solutions claimed by the present disclosure without departing from the spirit of the technical solutions of the present disclosure.

1. A crane, comprising:
a chassis;
a rotatable platform, rotatably arranged on the chassis and comprising a first end and a second end which are opposite to each other;
a main arm, comprising a first end hinged with the first end of the rotatable platform, and a second end for lifting a weight;
a mast, configured to luff the main arm, wherein a first end of the mast is hinged with the first end of the rotatable platform, and a second end of the mast is connected to the second end of the main arm and the second end of the rotatable platform; and
a first independent counterweight system, comprising a first independent counterweight, and a connecting structure connected between the first independent counterweight and the second end of the rotatable platform, wherein the connecting structure is configured to enable the first independent counterweight to be in a partial working state, and in the partial working state, the first independent counterweight is supported on the ground and the weight of the first independent counterweight is supported jointly by the ground and the rotatable platform.

2. The crane according to claim 1, wherein the connecting structure comprises a first lifting device; and the first lifting device is configured to lift the first independent counterweight, so that the first independent counterweight is supported on the ground or off the ground.

3. The crane according to claim 2, further comprising a counterweight fixedly arranged on the rotatable platform; and the first independent counterweight is detachably connected to the rotatable platform.

4. The crane according to claim 2, wherein the first independent counterweight is detachably connected to the rotatable platform; and the crane further comprises:
a counterweight, fixedly arranged on the rotatable platform;
a force sensor, arranged between the second end of the mast and the second end of the main arm, and configured to detect a pulling force of the main arm on the mast; and
a control system, signally connected to the force sensor and the first lifting device and configured to: cause the first lifting device to lift the first independent counterweight according to the detection result of the force sensor.

5. The crane according to claim 1, wherein the first independent counterweight system comprises a first connecting frame connecting the rotatable platform and the connecting structure and the first connecting frame extends away from the first end of the rotatable platform.

6. The crane according to claim 5, wherein the first connecting frame comprises a first telescoping mechanism arranged between the connecting structure and the rotatable platform; and the first telescoping mechanism is configured to drive the first independent counterweight to be close to or away from the first end of the rotatable platform.

7. The crane according to claim 1, further comprising:
a super-lifting arm frame, of which a first end is hinged with the first end of the rotatable platform and a second end is connected to the main arm and the second end of the mast; and
a second independent counterweight system, comprising a second independent counterweight, a second lifting device connected between the second independent counterweight and the second end of the super-lifting arm frame, and a second connecting frame connected between the second end of the rotatable platform and the second lifting device, wherein the second lifting device is configured to lift the second independent counterweight, so that the second independent counterweigh is supported on the ground or off the ground.

8. The crane according to claim 7, wherein the second connecting frame comprises a second telescoping mechanism; and the second telescoping mechanism is configured to drive the second independent counterweight to be close to or away from the first end of the rotatable platform.

9. The crane according to claim 7, wherein the crane comprises a counterweight fixedly arranged at the second end of the rotatable platform; and the second independent counterweight is detachably connected to the rotatable platform.
